(19) United States
(12) Patent Application Publication
(10) Pub. No.: US 2003/0000195 A1
(43) Pub. Date: Jan. 2, 2003

(54) Lawn mower guard device

(76) Inventor: Michael Watkins, Ft. Worth, TX (US)

Correspondence Address: Myers & Associates, Intellectual Property Law, P.C., Building 3, Suite 200, 1827 Powers Ferry Road, Atlanta, GA, 30339, US

(21) Appl. No.: 09/895,032

(22) Filed: Jun. 29, 2001

(51) Int. Cl. A01D 67/00

(52) U.S. Cl. 56/320.1

(57) ABSTRACT

A protective mulching device capable of quickly and interchangeably mounting to a lawn mower housing, wherein a magnetic mounting plate having exposed hook and loop fastener is easily and removably installed on the metal deck of a lawn mower proximate to the discharge opening, and wherein a broom-like strip having an arrangement of bristles on one side and hook and loop fastener on the other side is removably attached to the mounted plate on the lawn mower and is positioned so that the bristles at least partially obstruct the mower discharge opening, thereby encouraging grass clippings to remain within the cutting area for an extended time period, enhancing mulching effectiveness, and discouraging the passage of potentially dangerous projectiles therethrough.

### TECHNICAL FIELD

The present invention relates generally to mower safety devices and, more specifically, to a protective mulch enhancing device capable of mounting to a lawn mower, thereby enabling the shielding of people and property from mower generated projectiles, while at the same time mulching grass.

### BACKGROUND OF THE INVENTION

Proper maintenance of a lawn requires routine mowing and edging. Completion of these tasks can be dangerous. Stones and other objects are often picked up and thrown by mower blades, becoming high-speed projectiles. In addition, razor sharp blade edges have been responsible for countless accidental foot and hand injuries.

As a result, protective guards have been designed to inhibit the ejection of projectiles from the base of the housing and to prevent the accidental entry of feet and hands into the cutting area. Utilization of these protective shields requires semi-permanent installation, such as bolting through the mower housing. This disadvantageously complex installation process typically necessitates disassembly of mower components to provide access to inner housing surfaces. In addition to being time consuming and tedious, such disassembly and reassembly can also be dangerous, wherein the handling of sharp mower blades is required. Thus, installation and use of such shielding devices can be effectively discouraged.

Safety issues notwithstanding, routine lawn maintenance and mowing can be problematic. For instance, environmental concerns about landfills have led most to cease acceptance of grass and lawn clippings. Composting is one alternative, however, remains realistically unavailable to many. Direct mulching of grass clippings is an environmentally attractive alternative, wherein cut grass is mulched within the mower housing and then reintroduced onto the lawn.

Mulching devices have been designed for installation on existing mowers. Unfortunately, like the protective shields described above, utilization of these mulching devices requires semi-permanent installation, such as bolting through the mower housing. This disadvantageously complex installation process necessitates disassembly of mower components to provide access to inner blade housing and ejection chute surfaces. Moreover, mulching devices can be inherently dangerous, having their own sharp edges in addition to those of mower blades. Not only can these installation and safety issues discourage initial users, but as the blades and tines incorporated into these mulching devices become worn, the entire complicated process must be revisited to either sharpen or replace the apparatus.

Another disadvantage of the complicated attachment methods for mower shields and mulching plates is that a user must purchase a separate device for each mower to be utilized, since they are not readily interchangeable. Thus, an individual or lawn service needing more than one size mower to accomplish mowing of a variety of landscape terrains would require more than one mower shield or mulching plate, necessitating increased expenditures.

Therefore, it is readily apparent that there is a need for a mower guard capable of quickly and interchangeably mounting to any metal lawn mower housing, wherein a row of extended bristles are removably secured thereto, thereby enabling efficient mulching and quick replacement of worn parts, thus preventing the above-discussed disadvantages.

### BRIEF SUMMARY OF THE INVENTION

Briefly described, in a preferred embodiment, the present invention overcomes the above-mentioned disadvantages, and meets the recognized need for such a device, by providing a mower guard capable of quickly and interchangeably mounting to a lawn mower housing, wherein a row of bristles are removably secured thereto and extended therefrom, thereby enabling efficient mulching and interchangeability of parts.

According to its major aspects and broadly stated, the present invention is a protective mulching device capable of magnetically mounting to a lawn mower, thereby enabling the shielding of people and property from mower generated projectiles, while at the same time utilizing a row of bristles to contain and mulch grass cuttings.

More specifically, the present invention is an elongated, magnetic mounting plate for removably securing to the metal deck of a lawn mower, wherein the outer surface of the positioned mounting plate has hook and loop fastener exposed thereon. A correspondingly elongated strip of hook and loop fastener with a broom-like arrangement of bristles affixed thereto is removably secured to the positioned mounting plate. The broom-like strip is positioned to enable the extended, closely spaced bristles to partially obstruct the mower discharge opening, thereby encouraging grass clippings to remain within the cutting area for an extended time period, enhancing mulching effectiveness, and discouraging the passage of potentially dangerous projectiles therethrough.

A feature and advantage of the present invention is the ability of such a device to provide a lawn mower guard device that is simpler in construction than prior art devices and thus less expensive to manufacture.

A feature and advantage of the present invention is the ability of such a device to provide a lawn mower guard device that is easily and removably mounted to a lawn mower deck.

A feature and advantage of the present invention is the ability of such a device to provide a lawn mower guard device that limits the discharge opening of a mower, thereby increasing the retention time of grass clippings within the blade area and thus maximizing cutting and mulching thereof.

A feature and advantage of the present invention is the ability of such a device to protect individuals and property from potentially dangerous projectiles while also enhancing mulching effectiveness.

A feature and advantage of the present invention is the ability of such a device to increase the speed and safety of installation of lawn mower protective guards.

A feature and advantage of the present invention is the ability of such a device to increase the speed and safety of installation of lawn mower mulching attachments.

A feature and advantage of the present invention is the ability of such a device to provide an easily removable magnetic mount for a lawn mower mulching guard, thereby enabling quickly interchangeable use on a variety of mowers.

A feature and advantage of the present invention is the ability of such a device to provide an easily removable broom-like strip, thereby enabling quick replacement of worn elements.

A feature and advantage of the present invention is the ability of such a device to be inexpensively manufactured, thereby reducing the required material and labor costs.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a top view of a mounting plate component of a lawn mower guard device according to a preferred embodiment of the present invention, showing exposed hook and loop fastener thereon.

FIG. 2 is a perspective view of a bristle strip component of a lawn mower guard device according to a preferred embodiment of the present invention, showing an overturned corner having exposed hook and loop fastener thereon.

FIG. 3 is a perspective view of a lawn mower guard device according to a preferred embodiment of the present invention, showing the mounting plate component of FIG. 1 magnetically mounted on a lawn mower deck proximate to a discharge opening, and showing the bristle strip component of FIG. 2 fastened to said mounting plate, partially blocking the discharge opening.

### DETAILED DESCRIPTION OF THE PREFERRED AND ALTERNATE EMBODIMENTS

In describing the preferred and alternate embodiments of the present invention, as illustrated in the figures, specific terminology is employed for the sake of clarity. The invention, however, is not intended to be limited to the specific terminology so selected, and it is to be understood that each specific element includes all technical equivalents that operate in a similar manner to accomplish similar functions.

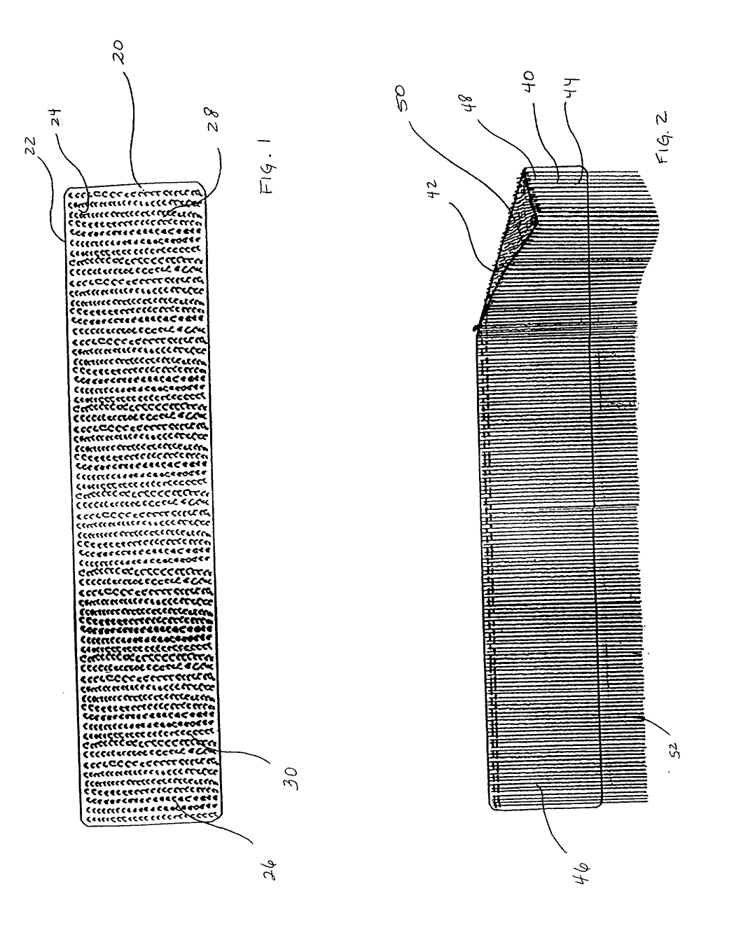

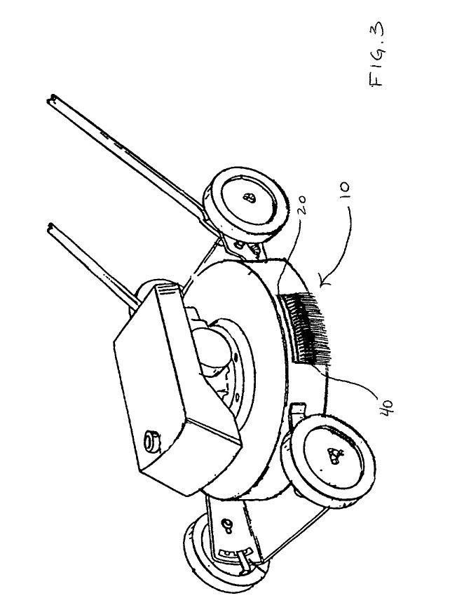

Referring now to FIGS. 1-3, the present invention is a lawn mower guard device 10 comprising mounting plate 20 and bristle strip 40. Preferably, mounting plate 20 is substantially rectangular shaped with first surface 22, second surface 24, first end 26 and second end 28. In the preferred form, mounting plate 20 has magnetic characteristics, thereby enabling secure, removable placement on a metal surface. However, while it is preferred that mounting plate 20 is magnetic, the novel lawn mower guard device 10 herein described could be utilized and configured wherein mounting plate 20 is not magnetic, but has a magnet mounted thereon thereby providing the intended result, specified features and advantages encompassed within the concept of the invention herein presented.

Preferably, first surface 22 of mounting plate 20 is substantially flat and magnetized, whereby first surface 22 can be removably secured to a metal deck of a lawn mower housing. Preferably, second surface 24 of mounting plate 20 is substantially flat with hook and loop fastener 30 affixed thereto. Hook and loop fastener 30 preferably extends substantially from first end 26 of mounting plate 20 to second end 28 thereof.

Preferably, mounting plate 20 is approximately four inches wide, however, while four inches is the preferred width, other widths ranging from approximately one to eight inches could be used depending upon the intended mower housing dimensions, thereby enabling utilization of lawn mower guard device 10 on a variety of personal and commercial mowers.

Bristle strip 40 is preferably substantially rectangular shaped with first surface 42, second surface 44, first end 46 and second end 48. Preferably, first surface 42 of bristle strip 40 is substantially flat with hook and loop fastener 50 affixed thereto. Hook and loop fastener 50 preferably extends substantially from first end 46 of bristle strip 40 to second end 48 thereof, whereby first surface 42 of bristle strip 40 is removably affixed to second surface 24 of mounting plate 20.

Preferably, bristle strip 40 is approximately three and one-half inches wide, however, while three and one-half inches is the preferred width, other widths ranging from approximately one-half to seven and one-half inches could be used, thereby corresponding to the dimensions of mounting plate 20.

A plurality of narrowly spaced, substantially fine diameter bristles 52 is preferably sewn to second surface 44 of bristle strip 40. Preferably, each bristle 52 is elongated straw. However, while straw is the preferred bristle material, other appropriately strong and flexible alternatives could be used, such as, for exemplary purposes only, nylon, metal, rubber or plastic. Each bristle 52 is preferably dimensioned to extend substantially across the width of bristle strip 40, protruding therefrom in a broom-like arrangement.

In an alternate embodiment, mounting plate 20 could be metal, plastic or other formed material with a magnet or magnets mounted thereon, thereby enabling secure, removable placement on a metal surface.

In an alternate embodiment, mounting plate 20 could be substantially arcuately shaped, thereby enabling placement on curved housing surfaces.

In an alternate embodiment, the width of bristle strip 40 could be decreased, thereby enabling placement of two bristle strips on mounting plate 20, wherein two bristle extension lengths would be provided for increased mulching action.

In an alternate embodiment, bristles 52 could be glued, welded, melded or otherwise affixed to second surface 44 of bristle strip 40.

In use, first magnetic surface 22 of mounting plate 20 is removably positioned on a metal deck of a lawn mower, proximate to the mower discharge opening. Hook and loop fastener 30 is thereby exposed on second surface 24 of mounting plate 20. Corresponding hook and loop fastener 50, exposed on first surface 42 of bristle strip 40, is secured to hook and loop fastener 30 on mounting plate 20, thereby affixing bristle strip 40 at a user selectable position relative to the mower discharge opening. The broom-like arrangement of bristles 52 affixed thereto extend, partially obstructing the mower discharge opening. The degree of obstruction is determined by user placement of bristle strip 40. Once in place, the bristles 52 of lawn mower guard device 10 restrict the ejection of potentially dangerous projectiles, such as stones, and also restrict the discharge of grass clippings, thereby causing increased retention thereof within the cutting area, enhancing mulching effectiveness.

If bristles 52 become worn, or if positioning adjustment is desired, bristle strip 40 is easily removed and replaced or repositioned by separating hook and loop fastener 50 on first surface 42 of bristle strip 40 from hook and loop fastener 30 on second surface 24 of mounting plate 20.

If removal of lawn mower guard device 10 is desired, first magnetic surface 22 is easily separated from the metal housing of the lawn mower without the use of any tools, wherein thereafter lawn mower guard device 10 can easily be placed onto another mower for further utilization.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A lawn mower guard device, comprising:
a mounting plate having an outer surface and an inner surface;
a bristled member;
a first hook and loop fastener carried by said outer surface of said mounting plate;
a second hook and loop fastener having an exposed surface and a rear surface, said bristled member carried by said rear surface and said exposed surface removably secured to said outer surface of said mounting plate; and
at least one magnet carried on said inner surface of said mounting plate.

2. The lawn mower guard device of claim 1, wherein said bristled member is straw bristles sewn onto said rear surface of said second hook and loop fastener.

3. The lawn mower guard device of claim 1, wherein said bristled member is plastic bristles sewn onto said rear surface of said second hook and loop fastener.

4. The lawn mower guard device of claim 1, wherein said bristled member is plastic bristles fused onto said rear surface of said second hook and loop fastener.

5. The lawn mower guard device of claim 1, wherein said bristled member is metal bristles extending from a substantially flat, substantially elongated plate, and wherein said plate is carried by said rear surface of said second hook and loop fastener.

6. The lawn mower guard device of claim 1, wherein said mounting plate is substantially arcuately shaped.

7. A mulch enhancing protective device for mounting on a lawn mower comprising:
an elongated mounting plate having a magnetic inner surface and an outer surface, said outer surface having hook and loop fastener carried thereby; and
an elongated brush having an inner surface, said inner surface having hook and loop fastener carried thereby for removably securing said elongated brush to said outer surface of said magnetic mounting plate.

8. The mulch enhancing protective device of claim 7, wherein said elongated brush has straw bristles sewn thereto.

9. The mulch enhancing protective device of claim 7, wherein said elongated brush has plastic bristles affixed thereto.

10. The mulch enhancing protective device of claim 7, wherein said elongated brush has metal bristles carried thereby.

11. A mulch enhancing protective shield device for limiting lawn mower discharge comprising:
a substantially rectangular, substantially flat magnetic plate having an outer surface, said outer surface having hook and loop fastener carried thereby; and
a substantially rectangular shield having an upper edge, a lower edge, an outer surface, said outer surface substantially covered with semi-flexible, closely spaced tines, said tines secured proximate to said upper edge and said tines extending past said lower edge, and an inner surface, said inner surface having hook and loop fastener carried thereby for removably securing said shield to said plate.

12. The mulch enhancing protective shield device of claim 11, wherein said semi-flexible, closely spaced tines are straw.

13. The mulch enhancing protective shield device of claim 11, wherein said semi-flexible, closely spaced tines are plastic.

14. The mulch enhancing protective shield device of claim 11, wherein said semi-flexible, closely spaced tines are metal.
